(19) United States
(12) Patent Application Publication
(10) Pub. No.: US 2025/0313062 A1
(43) Pub. Date: Oct. 9, 2025

(54) HEAT PUMP SYSTEM FOR A VEHICLE

(71) Applicants: HYUNDAI MOTOR COMPANY, Seoul (KR); KIA CORPORATION, Seoul (KR); HANON SYSTEMS, Daejeon (KR)

(72) Inventors: Hoyoung Jeong, Hwaseong-si (KR); Hochan An, Hwaseong-si (KR); Yeonho Kim, Hwaseong-si (KR); Jeawan Kim, Hwaseong-si (KR); Gwi Taek Kim, Hwaseong-si (KR); Yeong Jun Kim, Hwaseong-si (KR); Jae Yeon Kim, Hwaseong-si (KR); Man Hee Park, Hwaseong-si (KR); Hae Jun Lee, Daejeon (KR); Beom Seok Joo, Daejeon (KR); Yun Jin Kim, Daejeon (KR)

(73) Assignees: HYUNDAI MOTOR COMPANY, Seoul (KR); KIA CORPORATION, Seoul (KR); HANON SYSTEMS, Daejeon (KR)

(21) Appl. No.: 18/914,484

(22) Filed: Oct. 14, 2024

(30) Foreign Application Priority Data
Apr. 9, 2024 (KR) 10-2024-0047976

(51) Int. Cl. B60H 1/00

(52) U.S. Cl. CPC B60H 1/00907

(57) ABSTRACT

A heat pump system for a vehicle may be capable of performing cooling or heating of an interior of the vehicle by using a natural refrigerant and efficiently adjusting the temperature of a battery module by using one chiller where a refrigerant and a coolant exchange heat. The system includes an air conditioner unit with a compressor, a first heat-exchanger, a second heat-exchanger, a third heat-exchanger, and a fourth heat-exchanger that are connected through a refrigerant line to circulate a refrigerant through the refrigerant line. The system also includes a chiller connected to the refrigerant line through a first connection line. The chiller is configured to adjust a temperature of the coolant by heat-exchanging a coolant with the refrigerant supplied from the air conditioner unit.

### CROSS-REFERENCE TO RELATED APPLICATION

This application claims priority to and the benefit of Korean Patent Application No. 10-2024-0047976 filed in the Korean Intellectual Property Office on Apr. 9, 2024, the entire contents of which are incorporated herein by reference.

### BACKGROUND

### (a) Field of the Disclosure

The present disclosure relates to a heat pump system for a vehicle. More particularly, the present disclosure relates to a heat pump system for a vehicle capable of cooling or heating a vehicle interior by using a natural refrigerant and efficiently adjusting the temperature of a battery module by using one chiller where a refrigerant and a coolant exchange heat.

### (b) Description of the Related Art

Generally, an air conditioning system for a vehicle includes an air conditioner unit circulating a refrigerant in order to heat or cool an interior of the vehicle.

The air conditioner unit, which is used to maintain the interior of the vehicle at an appropriate temperature regardless of a change in an external temperature, is configured to heat or cool the interior of the vehicle. This is achieved by heat-exchange using a condenser and an evaporator in a process in which a refrigerant discharged by driving a compressor is circulated back to the compressor through the condenser, a receiver drier, an expansion valve, and the evaporator.

That is to say, the air conditioner unit lowers the temperature and humidity of the vehicle interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

An environment-friendly technology for a vehicle is a core technology of the future automobile industry. Advanced car makers have focused their energy on the development of an environmentally-friendly vehicle to achieve or meet environmental and fuel efficiency regulations.

Recently, in accordance with a continuous increased interest in energy efficiency and environmental pollution, the development of an environmentally-friendly vehicle capable of substantially substituting for an internal combustion engine vehicle is desirable. Environmentally-friendly vehicles are classified into electric vehicles driven using a fuel cell or electricity as a power source and hybrid vehicles driven using an engine and a battery.

Electric vehicles are in the spotlight as a means of transportation for the future to solve environmental problems and energy resource problems.

A heat pump system, which is an air conditioning apparatus for regulating the temperature of the vehicle interior, is applied to such an electric vehicle.

However, the refrigerant that is conventionally used in the heat pump system contains a large amount of environmentally regulated material, e.g., PFAS (Perfluoroalkyl and Polyfluoroalkyl Substances). Therefore, there is a demand for the development of a system capable of controlling the temperature of the vehicle interior by using new refrigerants, without PFAS and flammability issues, or natural refrigerants.

The above information disclosed in this Background section is only to enhance understanding of the background of the disclosure. Therefore, the Background section may contain information that does not form the prior art that is already known to a person of ordinary skill in the art.

### SUMMARY

The present disclosure provides a heat pump system for a vehicle capable of performing cooling or heating of the vehicle interior. The system does so by using a natural refrigerant in order to cope with environmental regulations and by efficiently adjusting the temperature of the battery module by using one chiller where the refrigerant and a coolant exchange heat.

In addition, the present disclosure provides a heat pump system for a vehicle capable of maximizing cooling and heating performance. The system does so by operating not only in the supercritical region, in which the pressure and temperature of the refrigerant is higher than a threshold pressure and temperature, but also in the subcritical region, by applying an R744 refrigerant that is a natural refrigerant using carbon dioxide.

A heat pump system for a vehicle may include an air conditioner unit having a compressor, a first heat-exchanger, a second heat-exchanger, a third heat-exchanger, and a fourth heat-exchanger that are connected through a refrigerant line to circulate a refrigerant through the refrigerant line. The system may also include a chiller connected to the refrigerant line through a first connection line. The chiller may be configured to adjust a temperature of the coolant by heat exchange between a coolant with the refrigerant supplied from the air conditioner unit. The air conditioner unit may further include a first control device provided on the refrigerant line between the first heat-exchanger and the second heat-exchanger. The first control device may be configured to control a flow of the refrigerant and selectively expand the refrigerant. The system may also include a second connection line having a first end connected to the refrigerant line between the compressor and the first heat-exchanger and having a second end connected to the first control device. The system may also include a third connection line having a first end connected to the first control device and having a second end connected to the refrigerant line between the fourth heat-exchanger and the compressor. The system may also include a second control device provided on the refrigerant line between the fourth heat-exchanger and the compressor. The system may also include a fourth connection line having a first end connected to the refrigerant line between the first heat-exchanger and the first control device and having a second end connected to the second control device. The system may also include a third control device provided on the refrigerant line between the third heat-exchanger and the fourth heat-exchanger. The third control device may be configured to control flow of the introduced refrigerant and selectively expand the refrigerant.

The first control device may include a first valve provided on the refrigerant line between the first heat-exchanger and the second heat-exchanger, a first expansion valve provided on the second connection line, and a second valve provided on the third connection line.

A second end of the second connection line may be connected to the refrigerant line provided between the first heat-exchanger and the second heat-exchanger through the first control device. A first end of the third connection line may be connected to the refrigerant line between the first heat-exchanger and the second heat-exchanger through the first control device.

The second control device may include a third valve provided on the refrigerant line between the fourth heat-exchanger and the compressor and may include a second expansion valve provided on the fourth connection line.

A first end of the first connection line may be connected to the refrigerant line between the compressor and the fourth heat-exchanger. A second end of the first connection line may be connected to the third control device.

The third control device may include a third expansion valve provided on the refrigerant line between the third heat-exchanger and the fourth heat-exchanger. The third control device may also include a fourth expansion valve provided on the first connection line at an upstream end of the chiller.

In a cooling mode of a vehicle interior, the refrigerant line connecting the compressor and the first heat-exchanger, and the refrigerant line connecting the first heat-exchanger and the first control device, may be closed by an operation of the first control device. The second connection line may be opened by the operation of the first control device such that the compressor and the second heat-exchanger are connected. The third connection line may be closed by the operation of the first control device and the fourth connection line may be closed by an operation of the second control device.

When cooling of a battery module is required in the cooling mode of the vehicle interior, the first connection line may be opened by an operation of the third control device.

The third control device may be configured to expand the refrigerant introduced through the first connection line and to introduce the expanded refrigerant to the chiller to cool the battery module by using the coolant having heat-exchanged with the refrigerant at the chiller. The third control device may also be configured to expand the refrigerant introduced through the refrigerant line and to introduce the expanded refrigerant to the fourth heat-exchanger such that the expanded refrigerant may be introduced to the fourth heat-exchanger.

In a heating mode of a vehicle interior, the refrigerant line connecting the first heat-exchanger and the first control device may be closed by an operation of the first control device. Further, the first connection line may be closed by an operation of the third control device, the second connection line may be closed by the operation of the first control device, the third connection line may be opened by the operation of the first control device, and the fourth connection line may be opened by an operation of the second control device. Also, a portion of the refrigerant line connecting the second control device and the compressor may be closed by the operation of the second control device.

The third control device may be configured to expand the refrigerant introduced from the fourth heat-exchanger and to introduce the expanded refrigerant into the refrigerant line.

The refrigerant having sequentially passed through the third heat-exchanger and the second heat-exchanger may be supplied to the compressor along the third connection line opened by the operation of the first control device and along the refrigerant line connecting the third connection line and the compressor.

In a hot gas heating mode of a vehicle interior, the refrigerant line connecting the first heat-exchanger and the first control device may be closed by an operation of the first control device. Further, the first connection line may be opened by an operation of the third control device, the second connection line may be opened by the operation of the first control device, the third connection line may be opened by the operation of the first control device, and the fourth connection line may be opened by an operation of the second control device. Also, the refrigerant line connecting the first control device, the second heat-exchanger, and the third heat-exchanger may be closed by the operation of the first control device. Also, a portion of the refrigerant line connecting the second control device and the first connection line may be closed by the operation of the second control device.

The first control device may be configured to expand the refrigerant supplied from the compressor through the second connection line and to introduce the expanded refrigerant into the third connection line.

The second control device may flow the refrigerant supplied from the first heat-exchanger through the fourth connection line to the fourth heat-exchanger. The third control device may be configured to expand the refrigerant introduced from the fourth heat-exchanger along the refrigerant line and to flow the expanded refrigerant to the chiller through the first connection line.

The second heat-exchanger, the third heat-exchanger, and the fourth heat-exchanger may be configured to cool or evaporate the introduced refrigerant according to a selective operation of the first control device, or the second control device, or the third control device.

The refrigerant may be an R744 refrigerant formed of carbon dioxide.

A heat pump system may further include a bypass line having a first end connected to the refrigerant line between the second heat-exchanger and the third heat-exchanger and having a second end connected to the refrigerant line between the third heat-exchanger and the fourth heat-exchanger. The system may also include a first opening/closing valve provided on the bypass line and a second opening/closing valve provided on the refrigerant line between the third heat-exchanger and the location where a second end of the bypass line and the refrigerant line are connected.

When frosting occurs at the third heat-exchanger in a heating mode of a vehicle interior, the bypass line may be opened by an operation of the first opening/closing valve. Also, a portion of the refrigerant line connected to the third heat-exchanger may be closed by an operation of the second opening/closing valve such that the refrigerant may not be supplied to the third heat-exchanger.

The first control device may include a first valve provided on the refrigerant line between the first heat-exchanger and the second heat-exchanger, a control valve provided on the second connection line, and a second valve provided on the third connection line.

As described above, according to an embodiment of a heat pump system for a vehicle, it is possible to cope with environmental regulations and improve the overall marketability of the vehicle by performing cooling or heating of the vehicle interior by using a natural refrigerant.

In addition, according to the disclosure, by applying the R744 refrigerant that is a natural refrigerant using carbon dioxide, cooling and heating performance may be maximized by operating the system not only in the supercritical region, in which the pressure and temperature of the refrigerant is higher than a threshold pressure and temperature, but also in the subcritical region, at the time of cooling and heating of the vehicle interior.

In addition, according to the disclosure, streamlining and simplification of the system may be achieved by efficiently adjusting the temperature of a battery module by using a single chiller that exchanges heat between the coolant and the refrigerant according to the mode of the vehicle.

In addition, according to an embodiment, by efficiently adjusting the temperature of the battery module, the optimal performance of the battery module may be enabled, and the overall travel distance of the vehicle may be increased due to the efficient management of the battery module.

In addition, according to the present disclosure, through streamlining of an entire system, it is possible to reduce manufacturing cost and weight and to improve space utilization.

### BRIEF DESCRIPTION OF THE DRAWINGS

FIG. 1 is a block diagram of a heat pump system for a vehicle according to an embodiment.

FIG. 2 is a schematic diagram of a first control device in a heat pump system for a vehicle according to a first embodiment.

FIG. 3 is a schematic diagram of a first control device in a heat pump system for a vehicle according to a second embodiment.

FIG. 4 is a schematic diagram of a second control device in a heat pump system for a vehicle according to an embodiment.

FIG. 5 is a schematic diagram of a third control device in a heat pump system for a vehicle according to an embodiment.

FIG. 6 is an operation diagram of a heat pump system for a vehicle, according to an embodiment, for cooling a battery module in a cooling mode of a vehicle interior.

FIG. 7 is an operation diagram according to a heating mode of a vehicle interior in a heat pump system for a vehicle according to an embodiment.

FIG. 8 is an operation diagram according to a hot gas heating mode of a vehicle interior in a heat pump system for a vehicle according to an embodiment.

FIG. 9 is an operation diagram of a heat pump system for a vehicle, according to another embodiment, for preventing frosting of a third heat-exchanger when heating a vehicle interior.

### DETAILED DESCRIPTION OF THE EMBODIMENTS

Embodiments of the present disclosure are hereinafter described in detail with reference to the accompanying drawings.

The various embodiments disclosed in the present specification and the constructions depicted in the drawings are only example embodiments of the present disclosure, and do not cover the entire scope of the present disclosure. Therefore, it should be understood that there may be various equivalents and variations at the time of applying the technical concepts of this specification.

In order to clarify the present disclosure, parts that are not related to the description have been omitted. Also, the same elements or equivalents are referred to with the same reference numerals throughout the specification.

Also, the size and thickness of each element may be arbitrarily shown in the drawings and the present disclosure is not necessarily limited thereto. Further, in the drawings, the thickness of layers, films, panels, regions, etc., may be exaggerated for clarity.

In addition, unless explicitly described to the contrary, the term “comprise” and variations thereof, such as “comprises” or “comprising”, should be understood to imply the inclusion of stated elements but not the exclusion of any other elements. The same understanding should apply to similar terms such as “have,” “include”, and the like.

Furthermore, terms, such as “ . . . unit”, “ . . . means”, “ . . . portions”, “ . . . part”, and “ . . . member” described in the specification, mean a unit of a comprehensive element that performs at least one function or operation. The refrigerant line disclosed and described herein may be referred to in sections or portions, such as first refrigerant line, second refrigerant line, etc. to distinguish segments of the refrigerant line that may be described as being disposed between various parts and components of the system.

When a component, device, element, or the like of the present disclosure is described as having a purpose or performing an operation, function, or the like, the component, device, or element should be considered herein as being “configured to” meet that purpose or perform that operation or function.

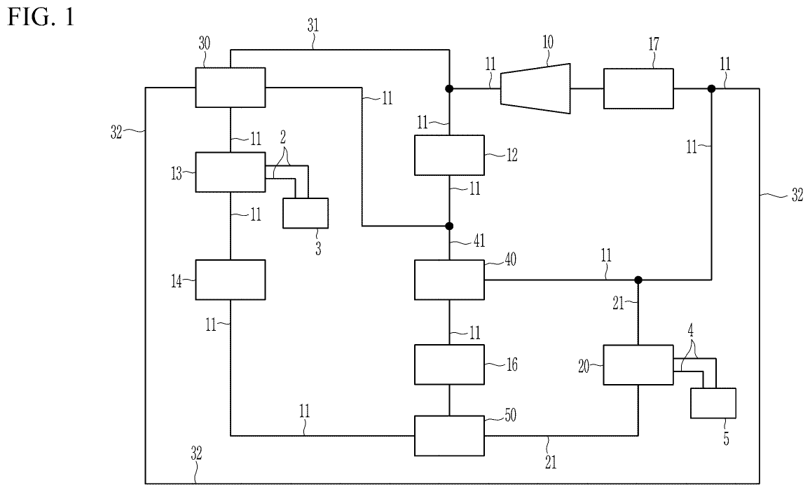

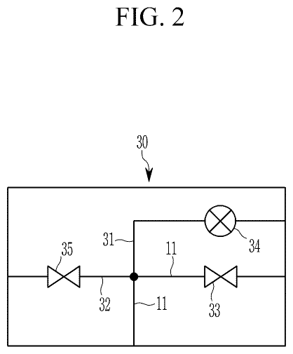

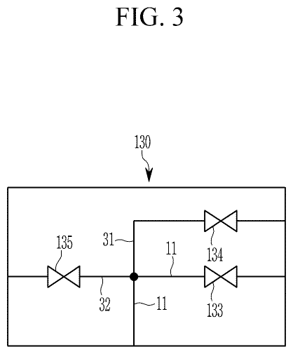

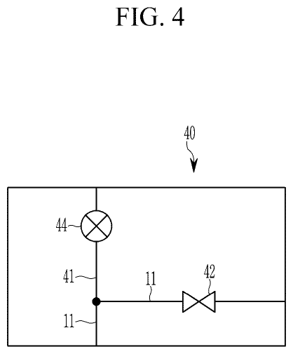

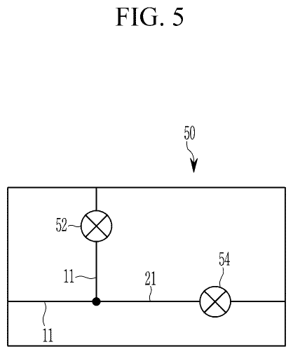

FIG. 1 is a block diagram of a heat pump system for a vehicle according to an embodiment. FIG. 2 is a schematic diagram of a first control device in a heat pump system for a vehicle according to a first embodiment. FIG. 3 is a schematic diagram of a first control device in a heat pump system for a vehicle according to a second embodiment. FIG. 4 is a schematic diagram of a second control device in a heat pump system for a vehicle according to an embodiment. FIG. 5 is a schematic diagram of a third control device in a heat pump system for a vehicle according to an embodiment.

A heat pump system for a vehicle according to an embodiment may perform cooling or heating of a vehicle interior by using a natural refrigerant in compliance with environmental regulations. The system may efficiently adjust a temperature of a battery module 5 by using one chiller 20 where the refrigerant and a coolant exchange heat with each other.

Here, the refrigerant may be an R744 refrigerant formed of carbon dioxide, which has an ozone depletion potential (ODP) of 0 and a global warming potential (GWP) of 1.

In other words, according to an embodiment of a heat pump system for a vehicle, by applying the R744 refrigerant, which is a natural refrigerant utilizing carbon dioxide, the system may operate not only in the supercritical region, in which the pressure and temperature of the refrigerant is higher than a threshold pressure and temperature, but also in the subcritical region, thereby maximizing cooling and the heating performance.

For such a purpose, the heat pump system according to an embodiment may include an air conditioner unit and the chiller 20.

Referring to FIG. 1, the air conditioner unit may include a compressor 10 connected through the refrigerant line 11 so as to circulate the refrigerant through the refrigerant line 11. The air conditioner unit may also include a first heat-exchanger 12, a second heat-exchanger 13, a third heat-exchanger 14, a fourth heat-exchanger 16, a first connection line 21, a first control device 30, a second connection line 31, a third connection line 32, a second control device 40, a fourth connection line 41, and a third control device 50.

First, the compressor 10 may compress the introduced refrigerant and flow the compressed refrigerant to the refrigerant line 11 such that the refrigerant may circulate along the refrigerant line 11.

The first heat-exchanger 12 may exchange heat between the air and the refrigerant selectively supplied from the compressor 10.

The second heat-exchanger 13 may be connected to the first heat-exchanger 12 through the refrigerant line 11. Accordingly, the refrigerant supplied to the refrigerant line 11 may pass through the second heat-exchanger 13.

Here, the second heat-exchanger 13 may be connected to an electrical component 3 through a first line 2 through which the coolant circulates.

The electrical component 3 may include a power conversion device such as an electric power control unit (EPCU), a motor, an inverter, an on-board charger (OBC), an autonomous driving controller, or the like.

The electrical component 3 configured as such may be connected to the first line 2 and cooled in a water-cooled manner.

In other words, the second heat-exchanger 13 may cool or evaporate the refrigerant through heat-exchange with the coolant supplied through the first line 2. The second heat-exchanger 13 may be a water-cooled gas cooler configured to exchange heat between the interiorly introduced refrigerant and the coolant.

In this embodiment, the third heat-exchanger 14 may be connected to the second heat-exchanger 13 through the refrigerant line 11. The third heat-exchanger 14 may be disposed in the front side of the vehicle and may cool or evaporate the refrigerant through heat-exchange with the air introduced from the outside during driving of the vehicle.

Since the R744 refrigerant is a supercritical refrigerant and does not have a phase change, unlike a typical refrigerant, the term “gas cooling” may be used instead of the term “condensation”.

In addition, the fourth heat-exchanger 16 may be provided, i.e., disposed on or along the refrigerant line 11 between the third heat-exchanger 14 and the compressor 10.

The first heat-exchanger 12, the third heat-exchanger 14, and the fourth heat-exchanger 16 configured as such may be an air-cooled gas cooler that exchanges heat between the air and the interiorly introduced refrigerant.

The first heat-exchanger 12 and the fourth heat-exchanger 16 may be provided inside a heating, ventilation, and air-conditioning (HVAC) module (not shown).

In this embodiment, an accumulator 17 may be provided on the refrigerant line 11 between the fourth heat-exchanger 16 and the compressor 10.

The accumulator 17 may supply only the gaseous refrigerant to the compressor 10. The efficiency and durability of the compressor 10 may be thereby improved.

In addition, although not shown in the drawings, an internal heat-exchanger may be provided inside the accumulator 17.

The internal heat-exchanger may exchange heat between the refrigerant cooled at the third heat-exchanger 14 and the low-temperature refrigerant discharged from the fourth heat-exchanger 16 and may supply the heat-exchanged refrigerant to the fourth heat-exchanger 16 and the compressor 10, respectively.

In this embodiment, the chiller 20 may be connected to the battery module 5 through a second line 4 through which the coolant circulates. Accordingly, the coolant may selectively circulate inside the chiller 20.

The chiller 20 may adjust a temperature of the coolant by heat-exchanging the coolant with the refrigerant supplied from the air conditioner unit. That is to say, the chiller 20 may be a water-cooled gas cooler configured to exchange heat between the interiorly introduced refrigerant and the coolant.

Here, the chiller 20 may be connected to the refrigerant line 11 through the first connection line 21. In other words, the chiller 20 may be provided on the first connection line 21.

A first end of the first connection line 21 may be connected to the refrigerant line 11 between the compressor 10 and the fourth heat-exchanger 16. A second end of the first connection line 21 may be connected to the third control device 50.

In this embodiment, the first control device 30 may be provided on the refrigerant line 11 between the first heat-exchanger 12 and the second heat-exchanger 13. Thus, the refrigerant introduced from the compressor 10 or the first heat-exchanger 12 may be selectively introduced into the second heat-exchanger 13 or the third connection line 32.

A first end of the second connection line 31 may be connected to the refrigerant line 11 between the compressor 10 and the first heat-exchanger 12. A second end of the second connection line 31 may be connected to the first control device 30.

In more detail, the second end of the second connection line 31 may be connected to the refrigerant line 11 through the first control device 30 between the first heat-exchanger 12 and the second heat-exchanger 13.

A first end of the third connection line 32 may be connected to the first control device 30. In more detail, the first end of the third connection line 32 may be connected to the refrigerant line 11 through the first control device 30 between the first heat-exchanger 12 and the second heat-exchanger 13.

A second end of the third connection line 32 may be connected to the refrigerant line 11 between the fourth heat-exchanger 16 and the compressor 10.

Accordingly, each of the second connection line 31 and the third connection line 32 may be connected to the first control device 30.

The first control device 30 configured as such may control the flow of the refrigerant and may selectively expand the refrigerant depending on configurations.

Here, as shown in FIG. 2 and FIG. 3, the first control device 30 may be vary in configuration, as depicted by first and second embodiments.

As shown in FIG. 2, the first control device 30 according to a first embodiment may include a first valve 33, a first expansion valve 34, and a second valve 35.

The first valve 33 may be provided on the refrigerant line 11 between the first heat-exchanger 12 and the second heat-exchanger 13. The first expansion valve 34 may be provided on the second connection line 31.

The second valve 35 may be provided on the third connection line 32.

The first valve 33 and the second valve 35 may be 2-way valves that control opening and closing of the refrigerant line 11 and the third connection line 32, respectively.

In a cooling mode of the vehicle interior, the first control device 30 according to a first embodiment configured as such may flow the refrigerant supplied from the compressor 10 through the second connection line 31 to the second heat-exchanger 13.

On the other hand, in a heating mode of the vehicle interior, the first control device 30 may flow the refrigerant introduced through the first heat-exchanger 12, the fourth connection line 41, the second control device 40, the fourth heat-exchanger 16, the third control device 50, the third heat-exchanger 14, and the second heat-exchanger 13 from the compressor 10 to the third connection line 32.

In addition, in a hot gas heating mode, the first control device 30 may expand the refrigerant introduced from the compressor 10 through the second connection line 31 and may flow the expanded refrigerant to the third connection line 32.

As shown in FIG. 3, the first control device 130 according to a second embodiment may include a first valve 133, a control valve 134, and a second valve 135.

The first valve 133 may be provided on the refrigerant line 11 between the first heat-exchanger 12 and the second heat-exchanger 13. The control valve 134 may be provided on the second connection line 31.

In addition, the second valve 135 may be provided on the third connection line 32.

The first valve 133, the control valve 134, and the second valve 135 may be 2-way valves configured to control opening and closing of the refrigerant line 11, the second connection line 31, and the third connection line 32, respectively.

In the cooling mode of the vehicle interior, the first control device 130 according to a second embodiment configured as such may flow the refrigerant supplied from the compressor 10 through the second connection line 31 to the second heat-exchanger 13.

On the other hand, in the heating mode of the vehicle interior, the first control device 130 may flow the refrigerant introduced through the first heat-exchanger 12, the fourth connection line 41, the second control device 40, the fourth heat-exchanger 16, the third control device 50, the third heat-exchanger 14, and the second heat-exchanger 13 from the compressor 10 to the third connection line 32.

In this embodiment, the second control device 40 may be provided on the refrigerant line 11 between the fourth heat-exchanger 16 and the compressor 10.

A first end of the fourth connection line 41 may be connected to the refrigerant line 11 between the first heat-exchanger 12 and the first control device 30. A second end of the fourth connection line 41 may be connected to the second control device 40.

As shown in FIG. 4, the second control device 40 may include a third valve 42 and a second expansion valve 44.

First, the third valve 42 may be provided on the refrigerant line 11 between the fourth heat-exchanger 16 and the compressor 10. The third valve 42 may be a 2-way valve configured to control opening and closing of the refrigerant line 11.

In addition, the second expansion valve 44 may be provided on the fourth connection line 41.

Here, when dehumidification is required in the heating mode of the vehicle interior, the second expansion valve 44 may expand the refrigerant introduced through the fourth connection line 41. Thus, the expanded refrigerant may be supplied to the fourth heat-exchanger 16.

In the cooling mode of the vehicle interior, the second control device 40 configured as such may flow the refrigerant supplied from the fourth heat-exchanger 16 to the compressor 10.

On the other hand, in the heating mode of the vehicle interior and the hot gas heating mode, the second control device 40 may flow the refrigerant introduced from the first heat-exchanger 12 through the fourth connection line 41 into the fourth heat-exchanger 16.

In this embodiment, the third control device 50 may be provided on the refrigerant line 11 between the third heat-exchanger 14 and the fourth heat-exchanger 16. The third control device 50 may control the flow of the introduced refrigerant and may selectively expand the refrigerant.

As shown in FIG. 5, the third control device 50 may include a third expansion valve 52 and a fourth expansion valve 54.

The third expansion valve 52 may be provided on the refrigerant line 11 between the third heat-exchanger 14 and the fourth heat-exchanger 16. In addition, the second expansion valve 54 may be provided on the first connection line 21 on an upstream end of the chiller 20.

An upstream end of the chiller 20 and a downstream end of the chiller 20 may be set based on a flow direction of the refrigerant.

In other words, based on the direction in which the refrigerant flows along the first connection line 21, the position at which the refrigerant is introduced into the chiller 20 may be defined as the upstream end of the chiller 20. The position at which the refrigerant is discharged from the chiller 20 may be defined as the downstream end of the chiller 20.

The third control device 50 configured as such may selectively expand the refrigerant introduced through the refrigerant line 11.

In addition, the third control device 50 may supply the refrigerant to one or all of the fourth heat-exchanger 16 and the chiller 20 through the refrigerant line 11 and the first connection line 21.

In other words, the third control device 50 may be selectively expand the refrigerant, while controlling the flow of the refrigerant.

Accordingly, the chiller 20 may adjust the temperature of the coolant by heat exchange between the coolant selectively introduced through the second line 4 and the refrigerant selectively supplied from the air conditioner unit.

The coolant having exchanged heat in the chiller 20 may circulate through the battery module 5 through the second line 4.

A water pump (not shown) may be provided on the first line 2 and the second line 4.

In other words, the coolant may circulate through the first line 2 and the second line 4 according to the operation of respective water pumps (not shown).

Accordingly, the coolant having exchanged heat with the refrigerant in the second heat-exchanger 13 and the chiller 20 may be selectively supplied to the electrical component 3 and the battery module 5. The temperature of the electrical component 3 and the battery module 5 may thereby be adjusted.

The third control device 50 may selectively expand the refrigerant depending on the cooling mode or the heating mode of the vehicle interior and may flow the expanded refrigerant into the chiller 20 through the first connection line 21.

In addition, the third control device 50 may expand the introduced refrigerant and may supply the expanded refrigerant to the chiller 20 through the first connection line 21. To the contrary, the third control device 50 may close the first connection line 21 such that the refrigerant may not be supplied to the chiller 20.

In more detail, for cooling the battery module 5 by using the coolant having heat-exchanged with the refrigerant at the chiller 20, the third control device 50 may open the first connection line 21.

Simultaneously, the third control device 50 may expand the introduced refrigerant. The expanded refrigerant may be introduced into the chiller 20 through the first connection line 21.

In other words, for cooling the battery module 5 in the cooling mode of the vehicle interior, the third control device 50 may expand the refrigerant discharged from the third heat-exchanger 14 and may introduce the expanded refrigerant in the state of having decreased its temperature to the chiller 20. The temperature of the coolant passing through the interior of the chiller 20 may thereby be further decreased.

Accordingly, the coolant having a temperature that has been lowered while passing through the chiller 20 may be introduced into the battery module 5, thereby achieving more efficiently cooling.

In addition, in the cooling mode of the vehicle interior, the third control device 50 may expand the introduced refrigerant and may flow the expanded refrigerant into the fourth heat-exchanger 16 through the refrigerant line 11.

To the contrary, in the heating mode of the vehicle interior, the third control device 50 may expand the refrigerant introduced from the fourth heat-exchanger 16. Thereafter, the third control device 50 may flow the expanded refrigerant to the third heat-exchanger 14.

Meanwhile, in the hot gas heating mode, the third control device 50 may expand the refrigerant introduced from the fourth heat-exchanger 16 and may supply the expanded refrigerant to the chiller 20 through the first connection line 21.

In the heat pump system configured as such, the second heat-exchanger 13, the third heat-exchanger 14, and the fourth heat-exchanger 16 may cool or evaporate the interiorly introduced refrigerant according to a selective operation of the first control device 30, or the second control device 40, or the third control device 50.

In other words, the second heat-exchanger 13, the third heat-exchanger 14, and the fourth heat-exchanger 16 may evaporate the refrigerant when the expanded refrigerant is introduced and may cool the refrigerant when the unexpanded refrigerant is introduced.

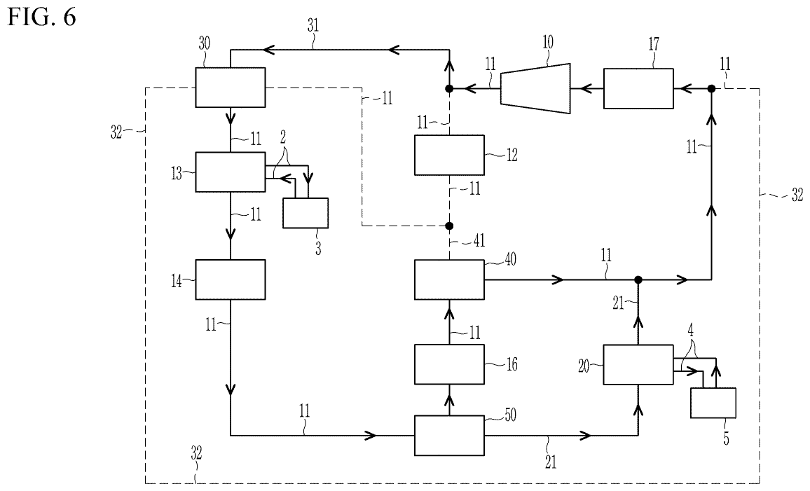

Hereinafter, an operation and action of a heat pump system for a vehicle according to an embodiment configured as described above will be described in detail with reference to FIGS. 6-8.

First, the operation for cooling the battery module 5 in the cooling mode of the vehicle interior is described in detail with reference to FIG. 6.

FIG. 6 is an operation diagram of a heat pump system for a vehicle, according to an embodiment, for cooling a battery module in the cooling mode of the vehicle interior.

Referring to FIG. 6, the coolant may circulate through the first line 2 by an operation of a water pump (not shown).

Accordingly, the coolant having passed through the electrical component 3 may be supplied to the second heat-exchanger 13 along the first line 2.

In the air conditioner unit, respective components may operate in order to cool the vehicle interior. Accordingly, the refrigerant may circulate along the refrigerant line 11.

The refrigerant line 11 connecting the compressor 10 and the first heat-exchanger 12 may be closed by an operation of the first control device 30. At the same time, the refrigerant line 11 connecting the first heat-exchanger 12 and the first control device 30 may be closed by the operation of the first control device 30.

In addition, the second connection line 31 may be opened by the operation of the first control device 30 such that the compressor 10 and the second heat-exchanger 13 are connected.

Accordingly, the refrigerant supplied from the compressor 10 may be supplied to the second heat-exchanger 13 along the second connection line 31.

Simultaneously, the third connection line 32 may be closed by the operation of the first control device 30. In addition, the fourth connection line 41 may be closed by an operation of the second control device 40.

The first connection line 21 may be opened by the operation of the third control device 50, for cooling the battery module 5.

At this time, the coolant may circulate through the second line 4 by an operation of a water pump (not shown). Accordingly, the coolant having passed through the battery module 5 may be supplied to the chiller 20 along the second line 4.

The third control device 50 may expand the refrigerant introduced to cool the battery module 5 by using the coolant having heat-exchanged with the refrigerant in the chiller 20 and may introduce the expanded refrigerant into the first connection line 21. The expanded refrigerant may be introduced into the chiller 20 along the first connection line 21.

Therefore, the coolant having passed through the chiller 20 may be cooled through heat-exchange with the expanded refrigerant supplied to the chiller 20.

In other words, the coolant passing through the chiller 20 may be cooled through heat-exchange with the expanded refrigerant supplied to the chiller 20. The coolant cooled at the chiller 20 may be supplied to the battery module 5 along the second line 4. Accordingly, the battery module 5 may be efficiently cooled by the coolant cooled in the chiller 20.

The refrigerant supplied from the compressor 10 may sequentially pass through the second heat-exchanger 13 and the third heat-exchanger 14 along the second connection line 31 connected to the refrigerant line 11.

The second heat-exchanger 13 may primarily cool the refrigerant by using the coolant flowing along the first line 2. In addition, the third heat-exchanger 14 may secondarily cool the refrigerant introduced from the second heat-exchanger 13 through heat-exchange with the air.

The refrigerant having sequentially passed through the second heat-exchanger 13 and the third heat-exchanger 14 may be introduced into the third control device 50 along the refrigerant line 11.

The third control device 50 may expand the refrigerant introduced through the refrigerant line 11 and introduce the expanded refrigerant to the fourth heat-exchanger 16 such that the expanded refrigerant may be introduced into the fourth heat-exchanger 16.

In other words, the third control device 50 may expand the refrigerant having passed through the third heat-exchanger 14. Thus, the expanded refrigerant may be supplied into the fourth heat-exchanger 16 and the chiller 20 and the third control device 50 may inflow a partial refrigerant among the expanded refrigerant to the first connection line 21.

Therefore, the refrigerant, which is in the low-temperature and low-pressure state by being expanded through the operation of the third control device 50, may be introduced into the chiller 20 through the first connection line 21.

Then, the refrigerant introduced into the chiller 20 may be heat-exchanged with the coolant supplied through the second line 4. After passing through the accumulator 17 along the refrigerant line 11 connected to the first connection line 21, the refrigerant may be introduced into the compressor 10.

A remaining refrigerant among the refrigerant expanded at the third control device 50 may flow along the refrigerant line 11 so as to cool the vehicle interior. Accordingly, the refrigerant may sequentially pass through the fourth heat-exchanger 16, the second control device 40, the accumulator 17, and the compressor 10.

The air introduced into the HVAC module may be cooled while passing through the fourth heat-exchanger 16 by the low-temperature refrigerant introduced into the fourth heat-exchanger 16.

At this time, the cooled air may cool the vehicle interior by being directly introduced into the vehicle interior.

The refrigerant having a cooling level that has been increased while sequentially passing through the second heat-exchanger 13 and the third heat-exchanger 14 may be expanded and supplied to the fourth heat-exchanger 16. Accordingly, the refrigerant may be evaporated at a further lower temperature.

In other words, in this embodiment, the second heat-exchanger 13 may cool the refrigerant through heat-exchange with the coolant. The third heat-exchanger 14 may cool the refrigerant through heat-exchange with the air, to more efficiently cool the R744 refrigerant made of carbon dioxide. The phase change heat transfer section of the refrigerant may thereby be better secured.

In addition, the refrigerant having secured more phase change heat transfer sections may be evaporated in the fourth heat-exchanger 16. Accordingly, the temperature of the air passing through the fourth heat-exchanger 16 may be further lowered, thereby improving the cooling performance and efficiency.

While repeatedly performing the above-described processes, in the cooling mode of the vehicle interior, the refrigerant may cool the vehicle interior. At the same time, the refrigerant may cool the coolant through heat-exchange while passing through the chiller 20.

The low-temperature coolant cooled by the chiller 20 may be introduced into the battery module 5 through the second line 4. Accordingly, the battery module 5 may be efficiently cooled by the supplied low-temperature coolant.

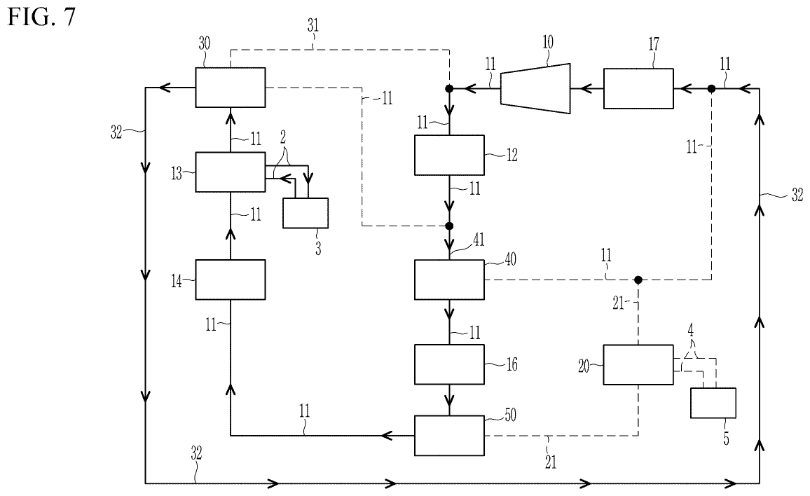

In this embodiment, the operation in the heating mode of the vehicle interior is described in detail with reference to FIG. 7.

FIG. 7 is an operation diagram in the heating mode of the vehicle interior of a heat pump system for a vehicle according to an embodiment.

Referring to FIG. 7, the coolant may circulate through the first line 2 by an operation of a water pump (not shown).

Accordingly, the coolant having passed through the electrical component 3 may be supplied to the second heat-exchanger 13 along the first line 2.

In the air conditioner unit, respective components may operate in order to heat the vehicle interior. Accordingly, the refrigerant may circulate along the refrigerant line 11.

Here, the refrigerant line 11 connecting the first heat-exchanger 12 and the first control device 30 may be closed by the operation of the first control device 30.

The first connection line 21 may be closed by the operation of the third control device 50. The second connection line 31 may be closed by the operation of the first control device 30.

The third connection line 32 may be opened by the operation of the first control device 30.

The fourth connection line 41 may be opened by the operation of the second control device 40. At the same time, a portion of the refrigerant line 11 connecting the second control device 40 and the compressor 10 may be closed by the operation of the second control device 40.

Accordingly, the refrigerant discharged from the compressor 10 may be introduced into the first heat-exchanger 12 along the refrigerant line 11.

Then, the refrigerant discharged from the first heat-exchanger 12 may be introduced into the second control device 40 along the fourth connection line 41 opened by the operation of the second control device 40.

The refrigerant discharged from the second control device 40 may be introduced into the fourth heat-exchanger 16 along the refrigerant line 11 connected to the fourth heat-exchanger 16.

Accordingly, the first heat-exchanger 12 and the fourth heat-exchanger 16 may cool the introduced refrigerant by using the air introduced into the HVAC module.

The refrigerant having passed through the fourth heat-exchanger 16 may be introduced into the third control device 50 along the refrigerant line 11.

The third control device 50 may expand the refrigerant introduced from the fourth heat-exchanger 16 and may introduce the expanded refrigerant into the refrigerant line 11.

Accordingly, the refrigerant expanded at the third control device 50 may be introduced into the third heat-exchanger 14 along the refrigerant line 11.

The third heat-exchanger 14 may recollect the ambient air heat while evaporating the expanded refrigerant through heat-exchange with the air.

In addition, the refrigerant having passed through the third heat-exchanger 14 may flow along the opened refrigerant line 11 and then may be introduced into the second heat-exchanger 13.

Accordingly, the second heat-exchanger 13 may evaporate the expanded refrigerant through heat-exchange with the coolant supplied through the first line 2. At this time, the second heat-exchanger 13 may recollect the waste heat of the electrical component 2 from the coolant having a temperature that has been increased by recollecting the waste heat from the electrical component 3.

The refrigerant having passed through the second heat-exchanger 13 may be introduced into the first control device 30 along the refrigerant line 11. Thereafter, the refrigerant may flow to the third connection line 32 that is opened by the operation of the first control device 30.

In other words, the refrigerant having sequentially passed through the third heat-exchanger 14 and the second heat-exchanger 13 may flow along the third connection line 32 opened by the operation of the first control device 30 and the refrigerant line 11 connecting the third connection line 32 and the compressor 10. The refrigerant may be supplied to the compressor 10 by passing through the accumulator 17.

The first heat-exchanger 12 and the fourth heat-exchanger 16 may cool the refrigerant by heat-exchange between the refrigerant and the air introduced inside HVAC module 12. The refrigerant primarily cooled at the first heat-exchanger 12 may be additionally cooled in the fourth heat-exchanger 16.

In other words, when the refrigerant having passed through the first heat-exchanger 12 is supplied to the fourth heat-exchanger 16 by the operation of the second control device 40, the fourth heat-exchanger 16 may cool the refrigerant by heat-exchange between the refrigerant and the air introduced inside HVAC module.

The refrigerant having passed through the fourth heat-exchanger 16 may be introduced into the third control device 50 along the refrigerant line 11. As described above, the third control device 50 may expand the refrigerant and may supply the expanded refrigerant to the third heat-exchanger 14.

The refrigerant having passed through the third heat-exchanger 14 may be supplied to the second heat-exchanger 13.

Accordingly, the third heat-exchanger 14 may evaporate the supplied refrigerant through heat-exchange with the air. At the same time, the second heat-exchanger 13 may evaporate the supplied refrigerant through heat-exchange with the coolant.

While repeatedly performing such an operation, the second heat-exchanger 13 and the third heat-exchanger 14 may recollect a waste heat of the electrical component 3 and the ambient air heat.

That is to say, the ambient air heat and the recollected waste heat of the electrical component 3 may be used for increasing the temperature of the refrigerant. Accordingly, the heat pump system may reduce the power consumption of the compressor 10 and improve the heating efficiency.

Meanwhile, the refrigerant discharged from the second heat-exchanger 13 may be supplied to the first control device 30 along the refrigerant line 11.

Then, the refrigerant may flow along the third connection line 32 from the first control device 30 and may be supplied to the accumulator 17 along the refrigerant line 11 connected to the third connection line 32.

The refrigerant having passed through the accumulator 17 may be supplied to the compressor 10.

In addition, the refrigerant compressed into a high-temperature and high-pressure state by the compressor 10 may be introduced back into the first heat-exchanger 12 along the refrigerant line 11.

As described above, the refrigerant supplied to the first heat-exchanger 12 and the fourth heat-exchanger 16, respectively, may increase the temperature of the air introduced into the HVAC module.

Accordingly, the air introduced from the outside may be converted into the high-temperature state while sequentially passing through the fourth heat-exchanger 16 and the first heat-exchanger 12. The air then may be introduced into the vehicle interior, thereby achieving heating of the vehicle interior.

Meanwhile, when dehumidification is required during an operation of the heating mode of the vehicle interior, the second control device 40 may expand the refrigerant having passed through the first heat-exchanger 12 and may supply the expanded refrigerant to the fourth heat-exchanger 16.

Then, the air introduced into the HVAC module may be dehumidified, while passing through the fourth heat-exchanger 16, by the refrigerant of the low-temperature state introduced into the fourth heat-exchanger 16. Thereafter, the air may be converted to a high-temperature state while passing through the first heat-exchanger 12 and then introduced into the vehicle interior, thereby smoothly heating and dehumidifying the vehicle interior.

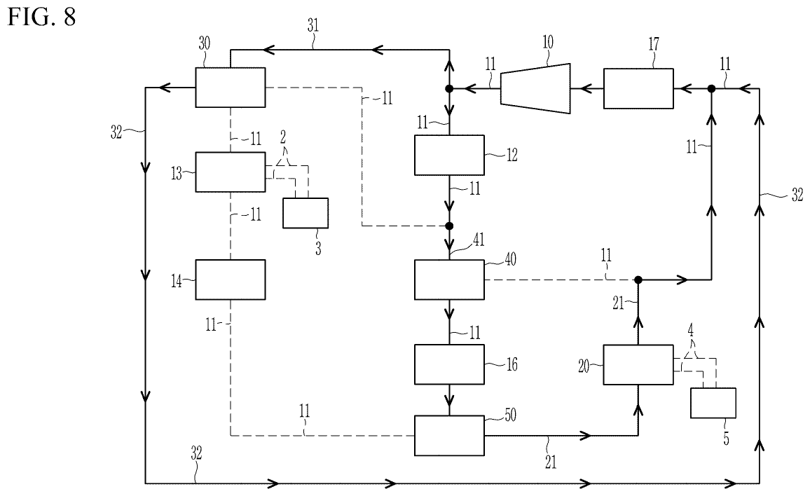

In addition, the operation in the hot gas heating mode is described in detail with reference to FIG. 8.

FIG. 8 is an operation diagram in the hot gas heating mode of a heat pump system for a vehicle according to an embodiment.

Referring to FIG. 8, when the ambient air heat, the waste heat of the electrical component 3, and a waste heat of the battery module 109 are not sufficient, the heat pump system may not recollect heat.

In other words, when heating the vehicle interior is required while the external or outside air temperature is low and the heat generated from the electrical component 3 and the battery module 5 is not sufficient in an early stage of driving the vehicle, the heat pump system may perform heating of the vehicle interior by directly using the high-pressure and high-temperature refrigerant.

As such, heating the vehicle interior by using only the refrigerant may be referred to as the hot gas heating mode.

In this embodiment, in the hot gas heating mode of the vehicle interior, the refrigerant line 11 connecting the first heat-exchanger 12 and the first control device 30 may be closed by the operation of the first control device 30.

At the same time, the refrigerant line 11 connecting the first control device 30, the second heat-exchanger 13, the third heat-exchanger 14, and the third control device 50 may be closed by the operation of the first control device 30.

Accordingly, the coolant may not circulate through the first line 2.

In other words, since the waste heat of the electrical component 3 and the ambient air heat are not sufficient, the refrigerant may not flow through the second heat-exchanger 13 and the third heat-exchanger 14.

In this embodiment, the first connection line 21 may be opened by the operation of the third control device 50. The second connection line 31 may be opened by the operation of the first control device 30.

The third connection line 32 may be opened by the operation of the first control device 30.

Accordingly, a partial refrigerant among the refrigerant supplied from the compressor 10 may be introduced into the first heat-exchanger 12 along the refrigerant line 11.

In addition, a remaining refrigerant among the refrigerant supplied from the compressor 10 may be introduced into the first control device 30 along the second connection line 31.

The first control device 30 may expand the refrigerant supplied from the compressor 10 through the second connection line 31 and may introduce the expanded refrigerant into the third connection line 32.

The fourth connection line 41 may be opened by the operation of the second control device 40.

Simultaneously, the portion of the refrigerant line 11 connecting the second control device 40 and the first connection line 21 may be closed by the operation of the second control device 40.

The second control device 40 may flow the refrigerant supplied from the first heat-exchanger 12, through the fourth connection line 41, to the fourth heat-exchanger 16 without expansion.

Accordingly, a partial refrigerant among the refrigerant compressed at the compressor 10 may be introduced into the first heat-exchanger 12 along the refrigerant line 11. The refrigerant having passed through the first heat-exchanger 12 may pass through the second control device 40 along the fourth connection line 41 and then may be introduced into the fourth heat-exchanger 16.

The first heat-exchanger 12 and the fourth heat-exchanger 16 may cool the refrigerant by heat-exchanging the refrigerant with the air introduced inside HVAC module. The refrigerant primarily cooled at the first heat-exchanger 12 may be additionally cooled in the fourth heat-exchanger 16.

The refrigerant supplied to the first heat-exchanger 12 and the fourth heat-exchanger 16, respectively, may increase the temperature of the air introduced into the HVAC module.

Accordingly, the air introduced from the outside may be converted into a high-temperature state while sequentially passing through the fourth heat-exchanger 16 and the first heat-exchanger 12. The air then may be introduced into the vehicle interior, thereby achieving heating of the vehicle interior.

The refrigerant discharged from the fourth heat-exchanger 16 may be introduced into the third control device 50.

The third control device 50 may expand the refrigerant introduced from the fourth heat-exchanger 16 along the refrigerant line 11. In addition, the third control device 50 may supply the expanded refrigerant to the chiller 20 through the first connection line 21.

That is to say, the expanded refrigerant may be introduced into the chiller 20 along the first connection line 21.

A remaining refrigerant among the refrigerant compressed at the compressor 10 may be introduced into the first control device 30 along the second connection line 31. The first control device 30 may expand the introduced refrigerant and may discharge the refrigerant expanded through the third connection line 32.

Accordingly, the refrigerant having passed through the chiller 20 may be introduced into the accumulator 17 along the refrigerant line 11 in a state of being mixed with the refrigerant introduced through the third connection line 32. Thereafter, the refrigerant may be introduced into the compressor 10 by passing through the accumulator 17.

When dehumidification is required during an operation of the hot gas heating mode of the vehicle interior, the second control device 40 may expand the refrigerant having passed through the first heat-exchanger 12 and may supply the expanded refrigerant to the fourth heat-exchanger 16.

Then, the air introduced into the HVAC module may be dehumidified, while passing through the fourth heat-exchanger 16, by the refrigerant of the low-temperature state introduced into the fourth heat-exchanger 16. Thereafter, the air may be converted to a high-temperature state while passing through the first heat-exchanger 12 and then may be introduced into the vehicle interior, thereby smoothly heating and dehumidifying the vehicle interior.

In other words, in this embodiment, when the external temperature is low and the heat source is not sufficient in an early stage of driving the vehicle, the vehicle interior may be heated by using the high-temperature refrigerant supplied from the compressor 10.

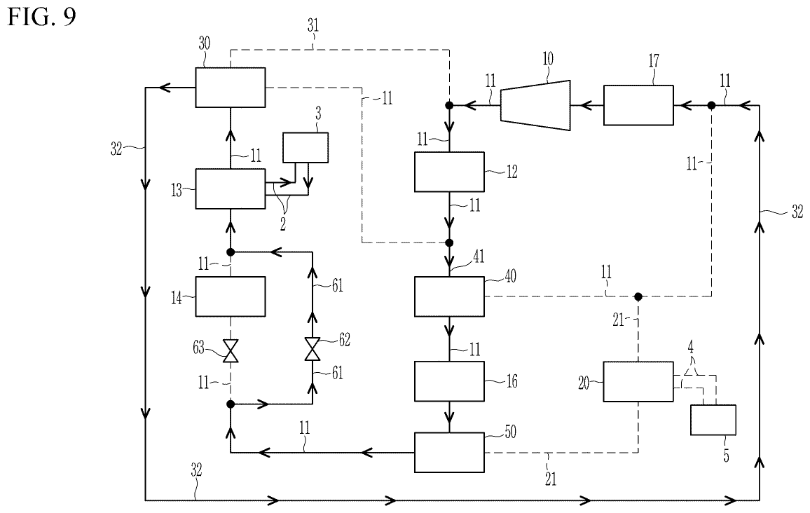

As shown in FIG. 9, during the heating mode of the vehicle interior operation, a heat pump system for a vehicle according to another embodiment may prevent frost accumulation due to frosting from being generated at the third heat-exchanger 14, depending on the external temperature.

FIG. 9 is an operation diagram of a heat pump system for a vehicle, according to another embodiment, for preventing frosting of the third heat-exchanger when heating the vehicle interior.

Referring to FIG. 9, in a heat pump system according to another embodiment, the connection structure of the refrigerant line 11 and the first to fourth connection lines 21, 31, 32, and 41, and the configuration of the first to fourth heat-exchangers 12, 13, 14, and 16 and the first to third control device 30, 40, and 50, are the same as the embodiment described above.

The heat pump system according to another embodiment may include a bypass line 61, a first opening/closing valve 62, and a second opening/closing valve 63.

First, a first end of the bypass line 61 may be connected to the refrigerant line 11 between the second heat-exchanger 13 and the third heat-exchanger 14.

A second end of the bypass line 61 may be connected to the refrigerant line 11 between the third heat-exchanger 14 and the fourth heat-exchanger 16.

The first opening/closing valve 62 may be provided on the bypass line 61. In addition, the second opening/closing valve 63 may be provided on the refrigerant line 11 between the third heat-exchanger 14 and the location where the second end of the bypass line 61 and the refrigerant line 11 are connected.

The first opening/closing valve 62 and the second opening/closing valve 63 may be 2-way valves that control opening and closing of the refrigerant line 11 and the bypass line 61, respectively.

In a heat pump system according to another embodiment configured as such, the coolant may circulate through the first line 2 by an operation of a water pump (not shown).

Accordingly, the coolant having passed through the electrical component 3 may be supplied to the second heat-exchanger 13 along the first line 2.

In the air conditioner unit, respective components may operate in order to heat the vehicle interior. Accordingly, the refrigerant may circulate along the refrigerant line 11.

Here, the refrigerant line 11 connecting the first heat-exchanger 12 and the first control device 30 may be closed by the operation of the first control device 30.

The first connection line 21 may be closed by the operation of the third control device 50. The second connection line 31 may be closed by the operation of the first control device 30.

The third connection line 32 may be opened by the operation of the first control device 30.

The fourth connection line 41 may be opened by the operation of the second control device 40. At the same time, the portion of the refrigerant line 11 connecting the second control device 40 and the compressor 10 may be closed by the operation of the second control device 40.

Accordingly, the refrigerant discharged from the compressor 10 may be introduced into the first heat-exchanger 12 along the refrigerant line 11.

Then, the refrigerant discharged from the first heat-exchanger 12 may be introduced into the second control device 40 along the fourth connection line 41 opened by the operation of the second control device 40.

The refrigerant discharged from the second control device 40 may be introduced into the fourth heat-exchanger 16 along the refrigerant line 11 connected to the fourth heat-exchanger 16.

Accordingly, the first heat-exchanger 12 and the fourth heat-exchanger 16 may cool the introduced refrigerant by using the air introduced into the HVAC module.

The refrigerant having passed through the fourth heat-exchanger 16 may be introduced into the third control device 50 along the refrigerant line 11. The third control device 50 may expand the refrigerant introduced from the fourth heat-exchanger 16 and may introduce the expanded refrigerant into the refrigerant line 11.

Accordingly, the refrigerant expanded at the third control device 50 may be introduced into the third heat-exchanger 14 along the refrigerant line 11.

When frosting occurs in the third heat-exchanger 14, the bypass line 61 may be opened by an operation of the first opening/closing valve 62.

Simultaneously, the portion of the refrigerant line 11 connected to the third heat-exchanger 14 may be closed by an operation of the second opening/closing valve 63 such that the refrigerant may not be supplied to the third heat-exchanger 14.

Then, the refrigerant supplied from the third control device 50 may flow to the bypass line 61 without passing through the third heat-exchanger 14.

Then, the refrigerant flowing through the bypass line 61 may be introduced into the second heat-exchanger 13.

Accordingly, the second heat-exchanger 13 may evaporate the expanded refrigerant through heat-exchange with the coolant supplied through the first line 2. At this time, the second heat-exchanger 13 may recollect the waste heat of the electrical component 2 from the coolant having a temperature that has been increased by recollecting the waste heat from the electrical component 3.

The refrigerant having passed through the second heat-exchanger 13 may be introduced into the first control device 30 along the refrigerant line 11. Thereafter, the refrigerant may flow to the third connection line 32 that is opened by the operation of the first control device 30.

In other words, the refrigerant having passed through the second heat-exchanger 13 may flow along the third connection line 32 opened by the operation of the first control device 30 and the refrigerant line 11 connecting the third connection line 32 and the compressor 10 and may be supplied to the compressor 10 by passing through the accumulator 17.

Meanwhile, the first heat-exchanger 12 and the fourth heat-exchanger 16 may cool the refrigerant by heat-exchange between the refrigerant and the air introduced inside HVAC module 12. The refrigerant primarily cooled at the first heat-exchanger 12 may be additionally cooled in the fourth heat-exchanger 16.

That is to say, when the refrigerant having passed through the first heat-exchanger 12 is supplied to the fourth heat-exchanger 16 by the operation of the second control device 40, the fourth heat-exchanger 16 may cool the refrigerant by heat-exchange between the refrigerant and the air introduced inside HVAC module.

The refrigerant having passed through the fourth heat-exchanger 16 may be introduced into the third control device 50 along the refrigerant line 11. As described above, the third control device 50 may expand the refrigerant and may supply the expanded refrigerant to the second heat-exchanger 13 through the bypass line 61.

Accordingly, the second heat-exchanger 13 may evaporate the supplied refrigerant through heat-exchange with the coolant. While repeatedly performing such an operation, the second heat-exchanger 13 may recollect the waste heat of the electrical component 3.

In other words, the recollected waste heat of the electrical component 3 may be used for increasing the temperature of the refrigerant. Accordingly, the heat pump system may reduce the power consumption of the compressor 10 and improve the heating efficiency.

The refrigerant discharged from the second heat-exchanger 13 may be supplied to the first control device 30 along the refrigerant line 11.

Then, the refrigerant may flow along the third connection line 32 from the first control device 30 and may be supplied to the accumulator 17 along the refrigerant line 11 connected to the third connection line 32.

The refrigerant having passed through the accumulator 17 may be supplied to the compressor 10.

In addition, the refrigerant compressed into a high-temperature and high-pressure state by the compressor 10 may be introduced back into the first heat-exchanger 12 along the refrigerant line 11.

As described above, the refrigerant supplied to the first heat-exchanger 12 and the fourth heat-exchanger 16, respectively, may increase the temperature of the air introduced into the HVAC module.

Accordingly, the air introduced from the outside may be converted into the high-temperature state while sequentially passing through the fourth heat-exchanger 16 and the first heat-exchanger 12. The air then may be introduced into the vehicle interior, thereby achieving heating of the vehicle interior.

In addition, when the external or outside air temperature is low, a heat pump system according to another embodiment may block the refrigerant from being introduced the third heat-exchanger 14 by using the bypass line 61. Accordingly, frost accumulation due to frosting may be prevented from being generated at the third heat-exchanger 14 at the time of heat-exchange between the refrigerant and the ambient air.

When dehumidification is required during the operation of the heating mode of the vehicle interior, the second control device 40 may expand the refrigerant having passed through the first heat-exchanger 12 and may supply the expanded refrigerant to the fourth heat-exchanger 16.

Then, the air introduced into the HVAC module may be dehumidified, while passing through the fourth heat-exchanger 16, by the refrigerant of the low-temperature state introduced into the fourth heat-exchanger 16. Thereafter, the air may be converted to a high-temperature state while passing through the first heat-exchanger 12 and then introduced into the vehicle interior, thereby smoothly heating and dehumidifying the vehicle interior.

Therefore, as described above, when a heat pump system for a vehicle according to an embodiment is applied, cooling or heating of the vehicle interior may be performed by using a natural refrigerant. Accordingly, it is possible to cope with environmental regulations and to improve the overall marketability of the vehicle.

In addition, according to the present disclosure, by applying the R744 refrigerant, which is a natural refrigerant utilizing carbon dioxide, at the time of cooling and heating of the vehicle interior, the system may operate not only in the supercritical region, in which the pressure and temperature of the refrigerant is higher than a threshold pressure and temperature, but also in a subcritical region, thereby maximize the cooling and heating performance.

In addition, according to the present disclosure, the temperature of the battery module 5, depending on the mode of the vehicle, may be efficiently adjusted by using one chiller 20 where the coolant and the refrigerant exchange heat with each other. Accordingly, streamlining and simplification of the system may be achieved.

In addition, according to an embodiment, by efficiently adjusting the temperature of the battery module 5, the optimal performance of the battery module 5 may be enabled. Also, the overall travel distance of the vehicle may be increased due to the efficient management of the battery module 5.

In addition, according to the present disclosure, through streamlining of an entire system, it is possible to reduce manufacturing cost and weight and improve space utilization.

While technical concepts of this disclosure have been described in connection with what are presently considered to be practical embodiments, it is to be understood that the disclosure is not limited to the disclosed embodiments. On the contrary, the present disclosure is intended to cover various modifications and equivalent arrangements included within the spirit and scope of the appended claims.

### DESCRIPTION OF SYMBOLS

2, 4: first and second lines
3: electrical component
5: battery module
10: compressor
11: refrigerant line
12, 13, 14, 16: first, second, third, and fourth heat-exchangers
17: accumulator
20: chiller
21: first connection line
30: first control device
31: second connection line
32: third connection line
40: second control device
41: fourth connection line
50: third control device
61: bypass line
62: first opening/closing valve
63: second opening/closing valve

What is claimed is:

1. A heat pump system for a vehicle, the heat pump system comprising:
a refrigerant line;
a first connection line;
an air conditioner unit including a compressor, a first heat-exchanger, a second heat-exchanger, a third heat-exchanger, and a fourth heat-exchanger that are connected through the refrigerant line to circulate a refrigerant through the refrigerant line; and
a chiller connected to the refrigerant line through the first connection line, the chiller configured to adjust a temperature of a coolant by heat-exchanging the coolant with the refrigerant supplied from the air conditioner unit,
wherein the air conditioner unit further includes
a first control device disposed on the refrigerant line between the first heat-exchanger and the second heat-exchanger, the first control device configured to control a flow of the refrigerant and selectively expand the refrigerant,
a second connection line having a first end connected to the refrigerant line between the compressor and the first heat-exchanger and having a second end connected to the first control device,
a third connection line having a first end connected to the first control device and having a second end connected to the refrigerant line between the fourth heat-exchanger and the compressor,
a second control device disposed on the refrigerant line between the fourth heat-exchanger and the compressor,
a fourth connection line having a first end connected to the refrigerant line between the first heat-exchanger and the first control device and having a second end connected to the second control device, and
a third control device disposed on the refrigerant line between the third heat-exchanger and the fourth heat-exchanger, the third control device configured to control flow of the introduced refrigerant and selectively expand the refrigerant.

2. The heat pump system of claim 1, wherein the first control device comprises:
a first valve disposed on the refrigerant line between the first heat-exchanger and the second heat-exchanger;
a first expansion valve disposed on the second connection line; and
a second valve disposed on the third connection line.

3. The heat pump system of claim 1, wherein:
a second end of the second connection line is connected to the refrigerant line disposed between the first heat-exchanger and the second heat-exchanger through the first control device; and
a first end of the third connection line is connected to the refrigerant line between the first heat-exchanger and the second heat-exchanger through the first control device.

4. The heat pump system of claim 1, wherein the second control device comprises:
a third valve disposed on the refrigerant line between the fourth heat-exchanger and the compressor; and
a second expansion valve disposed on the fourth connection line.

5. The heat pump system of claim 1, wherein:
a first end of the first connection line is connected to the refrigerant line between the compressor and the fourth heat-exchanger; and
a second end of the first connection line is connected to the third control device.

6. The heat pump system of claim 1, wherein the third control device comprises:
a third expansion valve disposed on the refrigerant line between the third heat-exchanger and the fourth heat-exchanger; and
a fourth expansion valve disposed on the first connection line at an upstream end of the chiller.

7. The heat pump system of claim 1, wherein, in a cooling mode of a vehicle interior:
the refrigerant line connecting the compressor and the first heat-exchanger, and the refrigerant line connecting the first heat-exchanger and the first control device are closed by an operation of the first control device;
the second connection line is opened by the operation of the first control device such that the compressor and the second heat-exchanger are connected;
the third connection line is closed by the operation of the first control device; and
the fourth connection line is closed by an operation of the second control device.

8. The heat pump system of claim 7, wherein, when cooling of a battery module is required in the cooling mode of the vehicle interior, the first connection line is opened by an operation of the third control device.

9. The heat pump system of claim 8, wherein the third control device is configured to:
expand the refrigerant introduced through the first connection line and introduce the expanded refrigerant to the chiller to cool the battery module by using the coolant having exchanged heat with the refrigerant at the chiller; and
expand the refrigerant introduced through the refrigerant line and introduce the expanded refrigerant to the fourth heat-exchanger such that the expanded refrigerant may be introduced to the fourth heat-exchanger.

10. The heat pump system of claim 1, wherein, in a heating mode of a vehicle interior:
the refrigerant line connecting the first heat-exchanger and the first control device is closed by an operation of the first control device;
the first connection line is closed by an operation of the third control device;
the second connection line is closed by the operation of the first control device;
the third connection line is opened by the operation of the first control device;
the fourth connection line is opened by an operation of the second control device; and
a portion of the refrigerant line connecting the second control device and the compressor is closed by the operation of the second control device.

11. The heat pump system of claim 10, wherein the third control device is configured to expand the refrigerant introduced from the fourth heat-exchanger and to introduce the expanded refrigerant into the refrigerant line.

12. The heat pump system of claim 10, wherein the refrigerant, having sequentially passed through the third heat-exchanger and the second heat-exchanger, is supplied to the compressor along the third connection line opened by the operation of the first control device and along the refrigerant line connecting the third connection line and the compressor.

13. The heat pump system of claim 1, wherein, in a hot gas heating mode of a vehicle interior:
the refrigerant line connecting the first heat-exchanger and the first control device is closed by an operation of the first control device;
the first connection line is opened by an operation of the third control device;
the second connection line is opened by the operation of the first control device;
the third connection line is opened by the operation of the first control device;
the fourth connection line is opened by an operation of the second control device;
the refrigerant line connecting the first control device, the second heat-exchanger, and the third heat-exchanger is closed by the operation of the first control device; and
a portion of the refrigerant line connecting the second control device and the first connection line is closed by the operation of the second control device.

14. The heat pump system of claim 13, wherein the first control device is configured to expand the refrigerant supplied from the compressor through the second connection line and to introduce the expanded refrigerant into the third connection line.

15. The heat pump system of claim 13, wherein:
the second control device flows the refrigerant supplied from the first heat-exchanger through the fourth connection line to the fourth heat-exchanger; and
the third control device is configured to expand the refrigerant introduced from the fourth heat-exchanger along the refrigerant line and to flow the expanded refrigerant to the chiller through the first connection line.

16. The heat pump system of claim 1, wherein the second heat-exchanger, the third heat-exchanger, and the fourth heat-exchanger are configured to cool or evaporate the introduced refrigerant according to a selective operation of the first control device, or the second control device, or the third control device.

17. The heat pump system of claim 1, wherein the refrigerant is an R744 refrigerant formed of carbon dioxide.

18. The heat pump system of claim 1, further comprising:
a bypass line having a first end connected to the refrigerant line between the second heat-exchanger and the third heat-exchanger and having a second end connected to the refrigerant line between the third heat-exchanger and the fourth heat-exchanger;
a first opening/closing valve disposed on the bypass line; and
a second opening/closing valve disposed on the refrigerant line between the third heat-exchanger and the location where a second end of the bypass line and the refrigerant line are connected.

19. The heat pump system of claim 18, wherein, when frosting occurs at the third heat-exchanger in a heating mode of a vehicle interior:
the bypass line is opened by an operation of the first opening/closing valve; and
a portion of the refrigerant line connected to the third heat-exchanger is closed by an operation of the second opening/closing valve such that the refrigerant may not be supplied to the third heat-exchanger.

20. The heat pump system of claim 1, wherein the first control device comprises:
a first valve disposed on the refrigerant line between the first heat-exchanger and the second heat-exchanger;
a control valve disposed on the second connection line; and
a second valve disposed on the third connection line.
